(19) United States
(12) Patent Application Publication
(10) Pub. No.: US 2010/0274684 A1
(43) Pub. Date: Oct. 28, 2010

(54) Inventory analysis

(76) Inventor: Hans-Göran Melander, Tumba (SE)

Correspondence Address: Hans-Goran Melander Imloq AB, Vasav.17, Tumba, 14731, SE

(21) Appl. No.: 12/596,963

(22) PCT Filed: Apr. 24, 2008
(86) PCT No.: PCT/SE08/00289

§ 371 Date: Dec. 22, 2009

Related U.S. Application Data
(60) Provisional application No. 60/913,739, filed on Apr. 24, 2007.

(51) Int. Cl. G06Q 10/00; G06T 11/20

(52) U.S. Cl. 705/28; 345/440

(57) ABSTRACT

A method for the control of an inventory, and hence the material flow in an inventory is provided. In the method the inventory composition and a ratio named Inventory Control Ratio is calculated and simulation regarding minimum stock and cyclic stock is performed. There is also provided a filtering function enabling a precise analysis of the articles in an inventory. There is also provided a computer system operating in accordance with the method, an inventory operated under the control of the method and a method for the building of diagrams in accordance with the method.

### TECHNICAL FIELD

The present invention relates to the control of an inventory, and hence of the material flow in an inventory, more specifically to a method for the control of an inventory, a computer system operating in accordance with said method and an inventory managed, operated, or run under the control of said method.

### BACKGROUND

Inventory is needed for different reasons. In a material flow, for example from supplier to customer, it can

be used to support production by being used to supply e.g. raw materials and work-in-process items. Work-in-process items are e.g. products which are present within an industry or factory and which are not finished, work still need to be done on them to bring them to a finished state. An inventory can also be used to support activities by being used to supply maintenance, repair and operating items. An inventory can as well be used for customer service by being used to supply finished goods and spare parts. Often several persons or functions in a business are interested in the inventory and their objectives may be different. For operations and sales the inventory as a possibility to satisfy demand, e.g. customer demand, is in focus. For management and financial functions the size of investments made can be more in focus. With the development of supply chains it also has become common that a supplier takes responsibility for the inventory of a customer, this is called Vendor Managed Inventory (VMI). The customer buying a VMI-solution often wants to be able to assess or analyse the quality of the inventory he is relying on.

Traditionally, inventory availability is a key figure in inventory control. Surprisingly many companies have however no measurement of the inventory availability. Inventory turnover rate is also commonly used as a key figure for management and financial follow up of an inventory. Occasionally overstock is calculated and listed for different articles or for the inventory as a whole.

Operations and sales functions and customers consider inventory availability important for different reasons. Sales functions see a high inventory availability as a means to support sales since if the inventory availability is high, the sales function know that there is almost always enough products available that can be delivered. For operations it is often an advantage with an inventory with a high inventory availability since that results in few back orders or a low backlog of orders. To have few back orders is good for operations since many back orders make production complicated to plan and execute. For a customer it is an advantage if the supplier of the customer has a high inventory availability since the customer can be confident that it gets the ordered goods and hence do not need to have its own inventory.

Inventory turn over rates are often considered important by management functions. In VMI-solutions focus often differ depending on who is the owner of the inventory.

Use of computer programs such as e.g. Excel and report generators are often used for analysis of an inventory but the results of the analysis is very dependent on skill in programming as well as skills in operations and in inventory management. The inventory goals as expressed by the inventory management are often not transformed into individual parameters for stock control.

In an inventory, different articles or Stock Keeping Units (SKUs) have different relations between the state or stock position of the article or SKU in the real, physical inventory and the state or stock position of the article or SKU in an inventory that control methods and control rules would result in if they were applied strictly. An article or a SKU is often defined by an article number. There are articles where demand has dropped since the last delivery to the inventory and where the reference or set value for an ideal state of the inventory given by the control rules have changed. There are articles where the demand is higher than the expected demand and where deliveries to the inventory to restore the inventory to the set or desired state, have not yet arrived.

In traditional methods for inventory control the problem or condition often occurs that summed up inventory values compared to summed up set or desired inventory goals or states can show a satisfying relation in spite of the fact that a big number of articles may be present in too big numbers and a big number of articles may be present in too low numbers in the inventory.

### SUMMARY

One aim of the method for inventory control described herein is to fully or at least partly address the aspects and problems mentioned above. For example, to fully or at least partly avoid the control of an inventory to be misguided by such a problem or condition as mentioned in the last paragraph of the BACKGROUND section.

With the method for inventory control described herein which e.g. utilises the information in databases of for example business systems and add-on systems for forecasting and inventory control, it is now possible to control an inventory, and to calculate, store, filter and present data, in a better way than in the background art.

The method for inventory control enables a visualized presentation of the inventory composition by which it is easy to see and agree upon, or calculate, strengths and weaknesses of a particular inventory or a part thereof, independent of interest or focus. Also need for actions as a matter for inventory management or inventory control becomes clear and easy to implement also in an automated system, e.g. with automated control of an automated inventory.

According to one aspect of the invention there is provided a method for controlling an inventory, wherein said method may comprise the steps of:
a. Selecting at least one article or Stock Keeping Unit according to at least one selection criterion, and
b. Performing at least one analysis on the at least one article or Stock Keeping Unit selected in step a., said analysis enabling the identification of interesting parts of the inventory, these parts being interesting for further investigation, and
c. Performing at least one simulation for the interesting parts of the inventory identified in the at least one analysis performed in step b.,
d. Setting at least one inventory control parameter based on the at least one simulation performed in step c.

In one embodiment, there is provided a method wherein the at least one selection criterion may be one or more of the following criteria: Stock Keeping Units from a certain source or vendor; Stock Keeping Units within a certain price range; Stock Keeping Units belonging to a certain article group or Stock Keeping Unit group; Stock Keeping Units within a certain range with reference to a characteristic, for example out-delivery frequency; all Stock Keeping Units in the inventory.

In another embodiment, there is provided a method wherein the at least one analysis in step b., mentioned before, may be one or more of the following: Inventory Control Ratio; Inventory Composition; wherein Inventory Composition may include analysis regarding Ok Stock, Under Stock, Over Stock, Severe Under Stock and/or Severe Over Stock.

In a further embodiment, there is provided a method wherein the at least one simulation in step c. may be one or more of the following: Simulation regarding Minimum Stock; Simulation regarding cyclic stock; Simulation regarding inventory availability; Simulation regarding service capability.

In still another embodiment, there is provided a method wherein the at least one simulation in step c. is performed on a, at least one, part of the inventory which has been selected using a Filtering Function.

In yet a further embodiment, there is provided a method wherein the Filtering Function is applied on at least one of the interesting parts of the inventory identified in step b. in claim 1.

In yet another embodiment, there is provided a method wherein the at least one inventory control parameter is one or more of the following: Input delivery quantity; Input delivery frequency; Reorderpoint; Output delivery quantity; Output delivery frequency.

According to another aspect there is provided a computer system operating in accordance with the described method, in any of its embodiments.

According to a further aspect there is provided an inventory operated under the control of the described method, in any of its embodiments.

According to yet another aspect there is provided a method of constructing or building a visual diagram for inventory analysis, wherein said method may comprise: using a representation that illustrates the Actual Inventory for at least one article, or group of articles, by defining at least one section for the Actual Inventory, preferably at least two sections.

In one embodiment there is provided a method of constructing or building a visual diagram wherein the at least one article, or group of articles, have been selected using at least one filtering criterion.

In one embodiment there is provided a method of constructing or building a visual diagram, wherein the at least one section comprises one or several of the following sections: Ok Stock; Over Stock; Severe Over Stock; Under Stock; Severe Under Stock.

### BRIEF DESCRIPTION OF THE DRAWINGS

FIG. 1 is a diagram with graduation in number of articles or SKUs showing the variable or parameter Inventory Composition for a selection of articles or SKUs,

FIG. 2 is a diagram with graduation in inventory value showing the variable or parameter Inventory Composition for a selection of articles or SKUs,

FIG. 3 is a diagram showing different types of analysis performed on the different groups of articles or SKUs identified in the Inventory Composition as visualized in FIGS. 1 and 2,

FIG. 4 is a diagram showing one example of the Filtering Function,

FIG. 5 is a diagram showing the relation between the value of the minimum inventory and the inventory availability,

FIG. 6 is a diagram showing the relation between the number of input deliveries per time period, e.g. one year, and the size or value of cyclic stock,

FIG. 7 is a drawing showing the interaction between an inventory and a computer system operating in accordance with the method for the control of an inventory.

FIG. 8 is a drawing schematically illustrating Minimum Stock, cyclic stock and reorderpoint.

### DETAILED DESCRIPTION

In an inventory there are articles or SKUs. For each article there may be different number of items or pieces of that article present in the inventory. An article or SKU is often defined by an article number. In the method described herein the terms Ok Stock, Under Stock and Over Stock are used. These terms may be used in relation to a specific article or in relation to a group comprising several articles. An article is said to have Ok Stock if the number of items of that article present in the inventory is within upper and lower limits set for that article. As an example, lets assume that for a specific article the upper limit is 150 pieces and the lower limit is 50 pieces. If the Actual Inventory of this article would be e.g. 75 pieces or items then this article would have an Ok Stock of 75 pieces. If the Actual Inventory of this article would be 30 pieces then this article would have an Ok Stock of 30 pieces and an Under Stock of 20 pieces. If the Actual Inventory of this article would be 200 pieces then this article would have an Ok Stock of 150 pieces and an Over Stock of 50 pieces.

The term Actual Inventory hence represents the number of items of an article, or a group of articles, which actually are present in the inventory. One example of a lower limit for the Actual Inventory of an article is the Minimum Stock. The Minimum Stock is the Actual Inventory necessary to reach a specified inventory availability. One example of an upper limit for the Actual Inventory of an article is the Minimum Stock plus the size, in items or value, of one input delivery of that article. The term inventory availability will be explained more in detail later but describes the ability of the inventory to meet the customer's demand for deliveries.

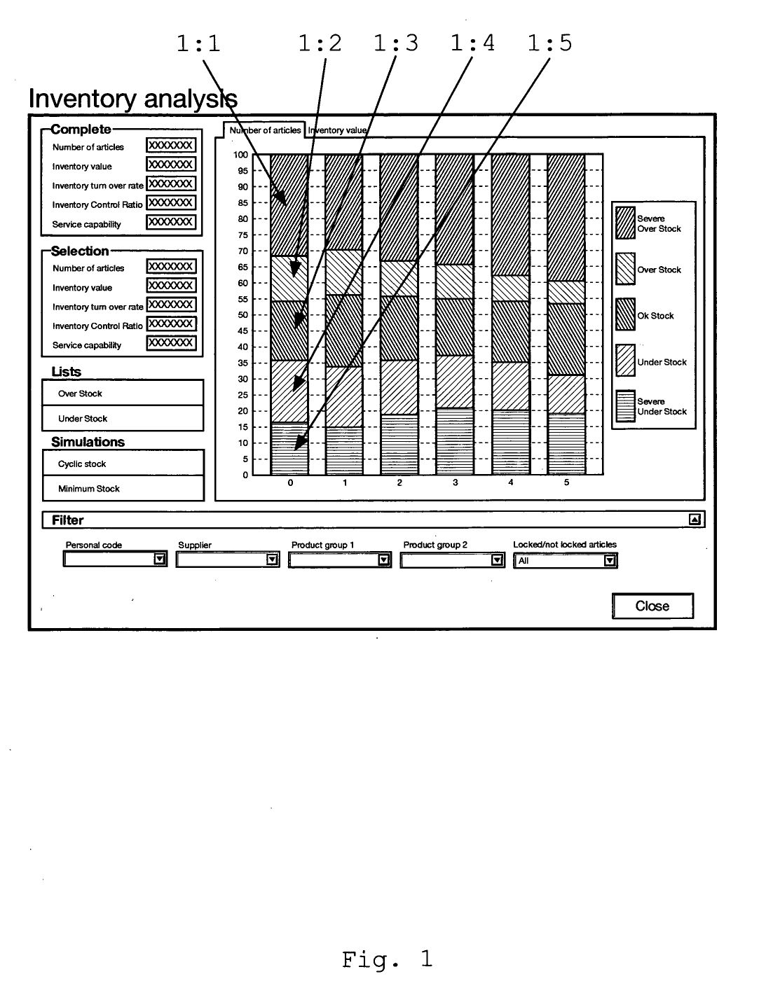

In FIGS. 1-3 the variable or parameter Inventory Composition, which is a part of the method, is visualized. The reference numbers;
1:1, 2:1, 3:1 denote articles or SKUs being in Severe Over Stock, i.e. having actual inventories that lie above the limits for Severe Over Stock,
1:2, 2:2, 3:2 denote articles or SKUs being in Over Stock, i.e. having actual inventories that lie within the limits for Over Stock,
1:3, 2:3, 3:3 denote articles or SKUs being in Ok Stock, i.e. having actual inventories that lie within the limits for Ok Stock,
1:4 denotes articles or SKUs being in Under Stock, i.e. having actual inventories that lie within the limits for Under Stock,
1:5 denotes articles or SKUs being in Severe Under Stock, i.e. having actual inventories that lie below the limits for Severe Under Stock,
2:5, 3:5 denote articles or SKUs being in Severe Under Stock or Under Stock, i.e. having actual inventories that lie within the limits for either Severe Under Stock or Under Stock.

These reference numbers can be seen as representing sub parameters or sub variables of the variable or parameter Inventory Composition. As shown above, the interval Under Stock may be handled as one group or it may be divided in sub groups, e.g. Under Stock and Severe Under Stock as shown above. Also the interval Over Stock may be handled as one group comprising the sub groups Over Stock and Severe Over Stock shown in FIGS. 1-3. But one may as well divide the interval Over Stock in more than two sub groups.

With the method for inventory control, inventory analysis, simulation, control and follow-up can be performed.

The method for inventory control is a means to distinctly or precisely measure, control and visually present the composition and actuality of any inventory or stock and the material flow to and from the inventory. It is a tool for planning, for inventory management and for supply chain management. It is a means to measure and control economical and financial aspects and interests for an inventory or stock. It collects data from databases with information about for example business, forecasting and inventory management.

By filtering by using defined characteristics, comparisons between different populations or groups of articles are easily performed. In FIG. 4 an example of the Filtering Function is shown. A population is a group of articles with similar characteristics, the articles are selected, with the Filtering Function, using a certain criterion or several criteria. Such criteria are e.g. articles with a certain degree of demand, articles that belong to a certain product group, articles with a lead time within a certain interval, articles within a certain price range or articles from a specific supplier or vendor. In the Filtering Function the different possible filtering criteria can be freely combined.

The method enables a system to inform about possibilities for improvements and it provides operatively responsable persons or control systems with information about actions to be taken by them as well as with information to be forwarded to management for decisions. It provides information to financial, economic control and top management about how well the investments in inventory are utilised. It enables or promotes the operatively responsable persons to transform the goals set by inventory management into control parameters for the inventory and into max and min goals for each article or SKU. Examples of control parameters are reorderpoints, safety or minimum stock levels, e.g. as a part of the reorderpoint or Material Requirement Planning (MRP), and order quantities.

The method for inventory control makes it possible to simulate the effect of various actions of the inventory control.

One part of the method is a ratio, named Inventory Control Ratio (ICR), which shows the relation or ratio between the fraction of the inventory fulfilling the goals for a number of articles and the Actual Stock Position for the same articles or SKUs. The Actual Stock Position is defined as the sum of three components; Ok Stock, Under Stock and Over Stock. Under Stock is calculated as the sum of: Minimum Stock minus Actual Inventory, per article or SKU or for a group of articles. Actual inventory for an article is the items actually present in the inventory of that article or SKU. Actual inventory may be expressed in number of items or in the value of the items. The value of the items may be expressed in a suitable currency.

The ratio ICR may be calculated as; ICR=(the value of the pieces that lie within the limits for Ok Stock)/((the value of the pieces that lie within the limits for OK stock)+(the value of the pieces that lie within the limits for Under Stock)+(the value of the pieces that lie within the limits for Over Stock)). Value may be e.g. purchase value, sales value or profit.

The ICR can be calculated based on inventory values. It can as well be calculated as the ratio between (the value of the part of the inventory which have an Actual Inventory within an upper and lower goal) and (the total value of the inventory). By the grafical presentations shown in FIGS. 1-3 the sums of Over Stocks, Under Stocks and stocks within set upper and lower goals, i.e. Ok Stocks, as well as the set goals can be visualised.

The goal for each article or SKU is suitably expressed as a minimum stock and a maximum stock level for each article or SKU. The goal set for every individual article or SKU is usually calculated by using one or several algorithms for a selection of articles. Examples of set values for minimum or safety stock are: always a certain number of days consumption as set level for minimum stock; always a number of standard deviations in the forecast for output delivery or demand, to give a certain probability for stockout or shortage, as set level for minimum stock; or values set by someones personal opinion. Examples of set values for maximum stock are: minimum stock+the quantity of one delivery; or a manually set maximum quantity.

The ICR shows the relation between the two sums of Actual Inventory composition as a ratio and compared to the goals. If the ICR is low it means that the Actual Inventory composition is far from the goals and if the ICR is close to 1 it means that the Actual Inventory composition is close to the goals.

The ICR may be presented as a figure, a number. The Inventory Composition, which is related to the ICR and part of the method, may be presented in one or more diagrams, e.g. as in FIGS. 1-3. In FIGS. 1-3 the Over Stock and Under Stock can be further split up in groups classified in different risks for obsolescence, e.g. Severe Over stock and Severe Under Stock as shown in FIGS. 1-3. In the diagrams in FIGS. 1-3, reference numbers 1:1, 2:1, 3:1 denote Severe Over stock, 1:2, 2:2, 3:2 denote Over Stock. The parts on the inventory denoted with 1:3, 2:3, 3:3 in the diagrams are value of the inventory in accordance with goals set. Parts of the inventory with Actual Inventory below that value can be split up in sub groups for Under Stock (ref. nr. 1:4) and Severe Under Stock (ref. nr. 1:5). Reference numbers 2:5 and 3:5 denote parts of the inventory having Actual Inventory either defined as Under Stock or Severe Under Stock. If a part of the inventory has an Actual Inventory that is defined as Under Stock that means that there is a certain risk for shortage of that part of the inventory, if a part of the inventory has an Actual Inventory that is defined as Severe Under Stock that means that the risk for shortage of that part of the inventory is even higher.

By the possibility of performing the above mentioned examination regarding Inventory Composition for differently defined groups of the inventory or of articles or SKUs, by using the Filtering Function, the method includes a further powerful tool.

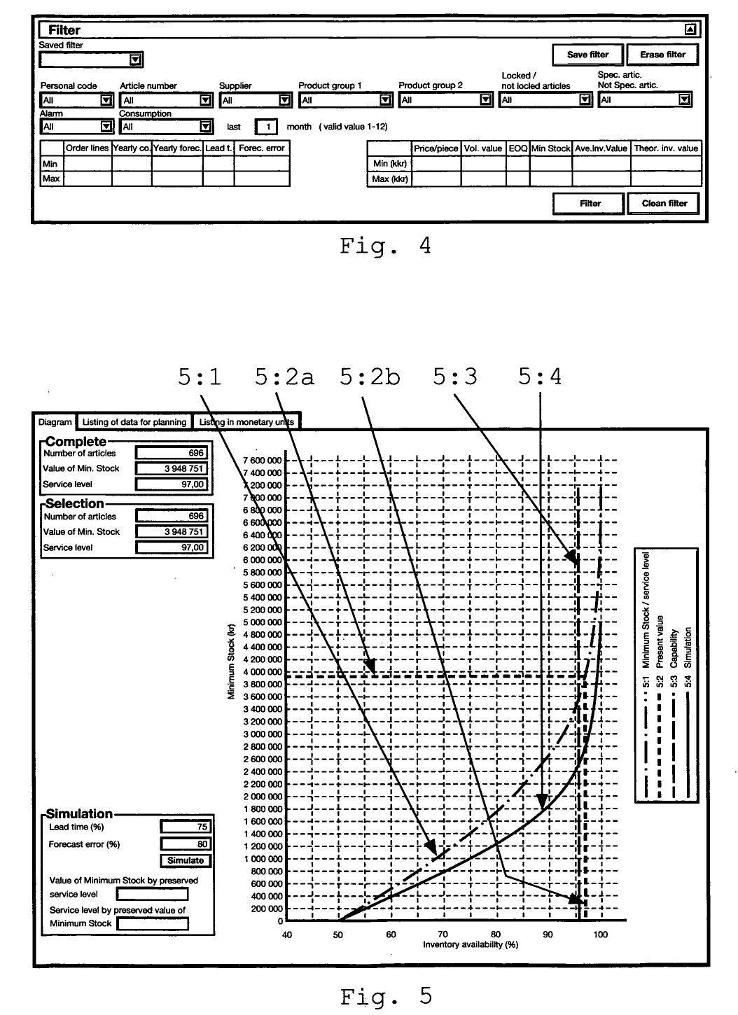

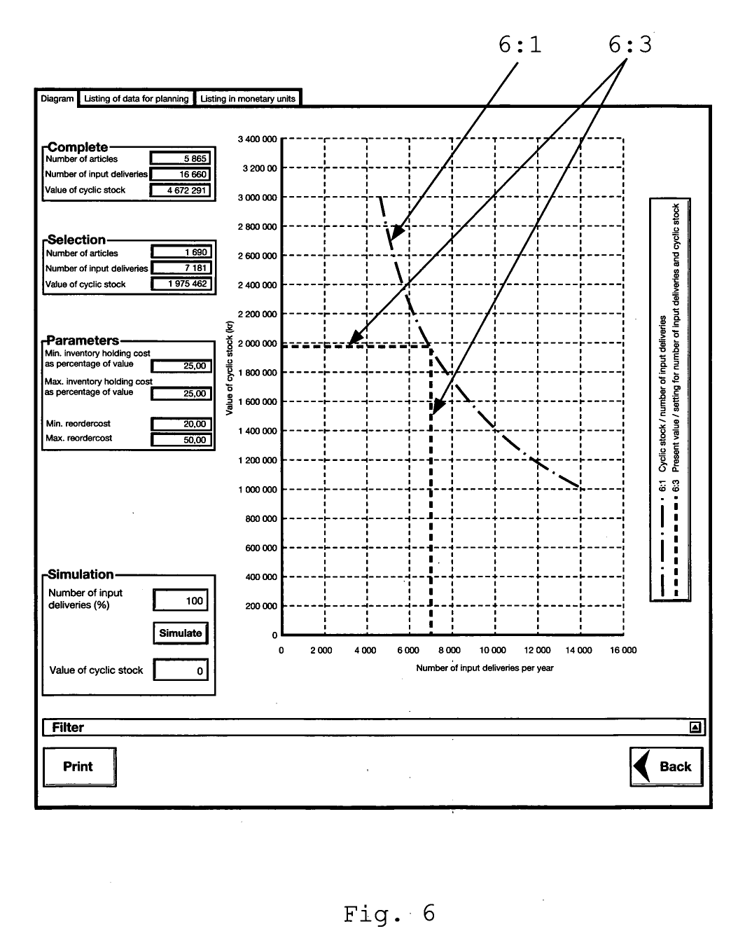

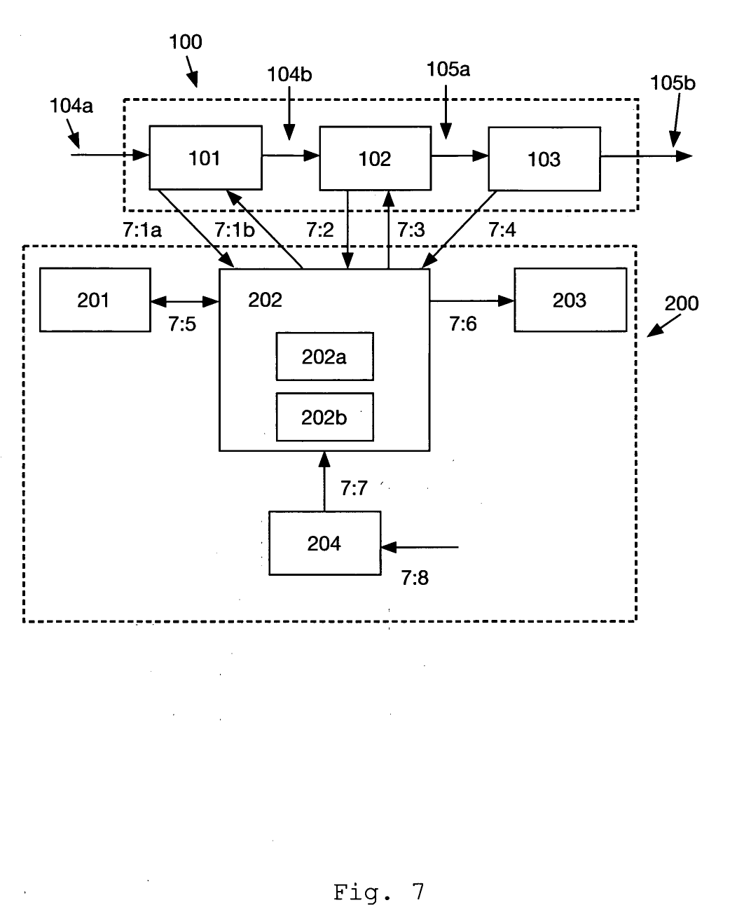

The ICR, the Inventory Composition, the use of the Filtering Function and the use of the simulation possibilities illustrated in FIGS. 5 and 6, each alone or together, constitute powerful tool(s) for inventory analysis, control and management and for the control of the flow to and from an inventory. The visualized presentation presents information vital for inventory management in an easy, distinct and clear way. The method is a tool for operations, for management and for top management.

The ICR can as well be calculated as expected value of the ratio between the margin of parts of the inventory having an Actual Inventory within the upper and lower goal and the margin of total number of pieces in stock. The ICR can also be calculated on ratios of sale or margins based on historical volume values or forecasted volume values. It is suitable to present the ICR as a figure, the ratio. As a visualisation the different values used in the calculation may be showed graphically, as in FIGS. 1-3 where the variable or parameter Inventory Composition and its sub parameters or sub variables are presented, and where the ICR is presented as a number. It is also possible to present the ICR graphically.

The use of the Filtering Function in the method is a powerful tool and enables an inventory to be analyzed more precisely than with previous methods. The graphical presentations may be combined with the Filtering Function that enables the user to investigate information more deeply by choosing different populations or groups of articles to find root causes and fields for improvements.

### Minimum Stock and Cyclic Stock Simulations

To see how changes of the inventory control parameters affect the characteristics of an inventory, two kinds of simulations are available, illustrated in FIGS. 5 and 6. Examples of inventory control parameters are; the size of one input delivery for an article or a group of articles, the reorderpoint for an article or a group of articles. The reorderpoint may be expressed as the Actual Inventory at which an input delivery for an article should be ordered so that the input delivery reaches the inventory before or at the point when the Actual Inventory of the article has reached the Minimum Stock. FIG. 5 shows a diagram that visualises how a change in inventory availability affects the value of the needed Minimum Stock. In FIG. 5 the inventory availability is indicated on the X-axis and the value of the needed Minimum Stock is indicated on the Y-axis. An inventory availability of 100 means that the risk for shortage is zero but would in theory mean that the necessary Minimum Stock must be infinite. In a real application a zero risk for shortage often can be reached with a Minimum Stock of a definite, but high, value. In FIG. 5 it is illustrated how much a certain degree of inventory availability costs in term of the value of the Minimum Stock. To change the size of the Minimum Stock it is e.g. possible to change the reorderpoint.

FIG. 6 shows a diagram that visualises how a change in input delivery quantity (the quantity of one specific input delivery), and hence in the number of input deliveries per time period, or the number of input delivery occasions per time period affect the cyclic inventory. In FIG. 6 the number of input delivery occasions are indicated on the X-axis and the value of the cyclic stock is indicated on the Y-axis. For a certain yearly total input delivery quantity it can be simulated how a change in the number of input delivery occasions affect the size of the cyclic stock. Cyclic stock is defined as one input delivery quantity but when the actual size or value of the cyclic stock is calculated for a certain point in time it is assumed that the cyclic stock is 50% of the input delivery quantity. As usual, this is valid for one article as well for a group of articles. See also FIG. 8 where Minimum Stock, cyclic stock and reorderpoint is illustrated.

Minimum Stock presentation and simulation, illustrated in FIG. 5, uses the well known correlation between the number of standard deviations in the demand for an article, which are needed as Minimum Stock to reach a certain probability for shortage, or a certain inventory availability. An inventory availability of 95% means that there is a 5% risk for a shortage in this article, or group of articles, which Minimum Stock value is shown on the Y-axis.

The Minimum Stock simulation is presented with the known relation curve combined with a calculation of the inventory's actual position of Minimum Stock and service availability. In the simulation or calculation of Minimum Stock one enters values for e.g. desired inventory availability, lead times from suppliers for articles, historical variations in demand and/or historical forecasting errors??? and in the diagram in FIG. 5 one can see, graphically and in numbers, how changes in these parameters affect the value of the Minimum Stock, and the values of the parameters which may have been left unchanged.

Cyclic stock is the part of inventory value controlled by the quantities of supply or input delivery and is for a number of articles often considered to be the value of the sum of each articles supply quantity divided by two, as mentioned before as well. The graphical presentation of cyclic stock may be made in a diagram, as in FIG. 6, showing, for a chosen population of articles, the sum value of theoretically calculated cyclic stock as a function of the number of input deliveries per year calculated as: (the sum of every article's or SKU's yearly input quantity) divided by (the input delivery quantity).

The graphical presentation in FIG. 6 is also showing the effects as a curve if the number of input deliveries are reduced or increased. The simulated results are presented in the graphical form, as well as in figures.

There may also be presented a summed presentation in which a number of key figures or factors are shown, for the chosen population as well as for the whole inventory. Key figures or factors to be presented may be:
Inventory value calculated as: The sum of the values for each of the articles in the inventory. The value of an article is calculated as the value of one item of the article multiplied with the Actual Inventory for that article. The Actual Inventory is the number of items of that article which is present in the inventory.
The volume value calculated for the chosen population as: the sum of the yearly demand multiplied with the value of one item of a certain article or SKU value.
Inventory turn over rate for the chosen population calculated as: the volume value divided by the inventory value.

The above mentioned are well known key figures.

Also the Inventory Control Ratio, ICR is presented, and it may be calculated as the ratio: (the value of the part of the inventory which is fulfilling set goals) divided by (the total value of: inventory fulfilling the set goals, inventory in excess of set goals and inventory missing to reach the minimum goals set).

Also the inventory capability may be presented. It is calculated as the inventory availability the chosen population would have provided that the Actual Inventory and the order intake or demand would remain the same for a certain period of time, e.g. one year.

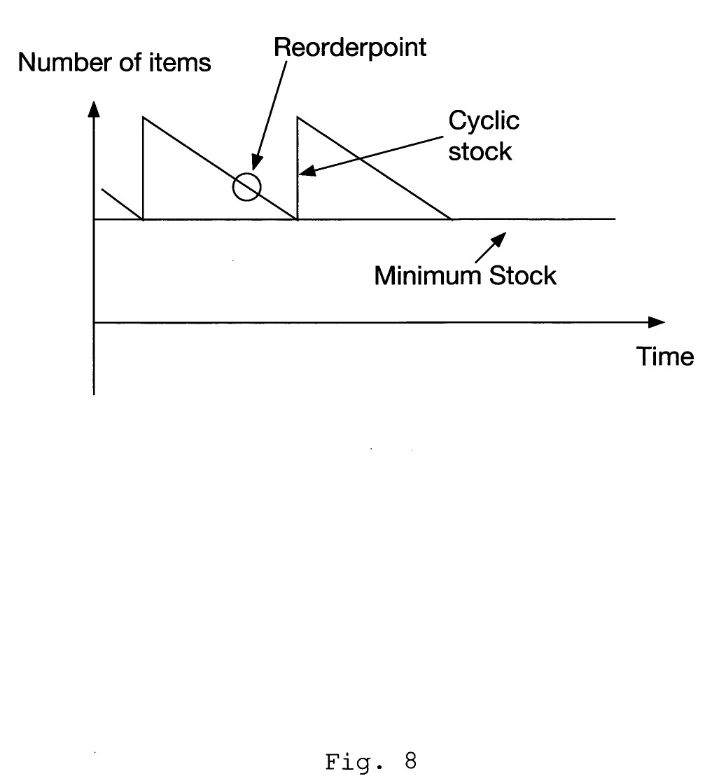

The method may be run on a computer system 200, one example of such a computer system 200 is shown in FIG. 7 together with a schematic representation of an inventory 100. The inventory 100 comprises an inventory input function 101, an inventory storage 102, and an inventory output function 103, for example outgoing orders. The computer system 200 comprises a data storage 201, a processing unit 202, a display unit 203 and an input unit 204. The processing unit 202 may comprise a first sub processing unit 202a and a second sub processing unit 202b. The arrows 104a, 104b symbolises material, articles or goods being delivered or input to the inventory. The arrows 105a, 105b symbolises material, articles or goods being delivered or output from the inventory. The arrows pointing to or from any of the parts of the computer system denotes the direction of information flow. Data input to the processing unit 202 from the inventory comprises:
Information from the inventory input function 101 about delivery of articles, e.g. when and how many items of each article, to the inventory storage 102. This data input is illustrated at 7:1a,
Information from the inventory storage 102 about articles present in the inventory storage 102. This data input is illustrated at 7:2,
Information from the inventory output function 103 about delivery and demand of articles, e.g. when and how many items of each article are delivered from the inventory storage 102, and not yet delivered demand. This data input is illustrated at 7:4.

The processing unit 202 stores data in and retrieves data from the data storage 201, this data flow is illustrated at 7:5. The processing unit 202 outputs data to be displayed, shown at 7:6, to the display unit 203, and an operator can input desired or set values for certain parameters regarding the inventory 100 via the input unit 204, this data input is shown at 7:8. At 7:7 it is shown that this data is transmitted to the processing unit 202. Parameters entered to the input unit 204 may for example be desired inventory availability, desired deliverance capability or input data or parameters for Minimum Stock calculation. These parameters may have a certain relation to characteristics such as output deliverance frequency or selling price. Based on the input data the method calculates control signals or inventory control parameters, which are sent to the inventory input function 101, the transmittal of these signals is shown at 7:1b. Examples of such control signals or inventory control parameters are reorderpoints, input delivery quantities and input delivery frequencies.

The processing unit 202 calculates inventory characteristics such as Inventory Composition and ICR for the whole inventory or for different selections of articles, selected by using different settings of the Filtering Function. This calculation may be done by the first sub processing unit 202a. Dependent on the input data from input unit 204 and/or analysis or simulation regarding for example minimum stock and cyclic stock, the processing unit 202 calculates different inventory control parameters, e.g. input delivery frequencies, input delivery quantities and reorderpoints for an article or SKU or groups of articles or SKUs. This calculation may be done by the second sub processing unit 202b. The processing unit 202 sends control signals, i.e. inventory control parameters, to the input function 101 in terms of e.g. input delivery quantity for a given article or SKU or group of articles or SKUs, at a given point in time. Inventory control parameters may also be sent from the processing unit 202 to the inventory storage 102, shown at 7:3.

The parameters and characteristics mentioned above may also be defined for a specific article or for an arbitrary selection of articles.

In one embodiment the calculations and simulations according to the method are performed as follows.

i) In a first step the inventory characteristics ICR and Inventory Composition are calculated. In the Inventory Composition Ok Stock, Under Stock and Over Stock are calculated. Eventually sub variables or sub groups Severe Under Stock and Severe Over Stock are calculated within the groups or variables Under Stock and Over Stock.

ii) In a second step the Filtering Function is applied to the article(s) of interest identified in step i). Articles of interest may be articles having Under Stock or Over Stock or where the ration ICR is not satisfactory. For different settings of the Filtering Function, which result in differently composed groups of articles, simulations and/or calculation for Minimum Stock and cyclic stock are performed on these article(s) of interest. By comparing the simulations the most favourable way of changing inventory control parameters so as to reduce problems with Under Stock, Over Stock and/or a low ICR can be found. The most favourable way may e.g. be defined in terms of achieved service levels, inventory availability or in terms of costs, e.g. the most economical way of changing the inventory control parameters so as to achieve the desired effect of reducing or eliminating the problems identified in step i). Since the simulations/calculations regarding Minimum Stock and cyclic Stock show the value of the Minimum Stock and cyclic stock, costs for different alternatives can easily be compared. As illustrated in FIG. 7, this method can also be implemented in an automated system.

In an inventory, the value of the items in the inventory may be e.g. purchase price, selling price or profit margin.

### Relating to FIG. 1

A diagram showing number of articles or SKUs in the different groups the system is using. Planning can be more accurate by analysis concentrated on different groupings such as: number of articles or SKUs, number of orderlines per SKU per time unit.

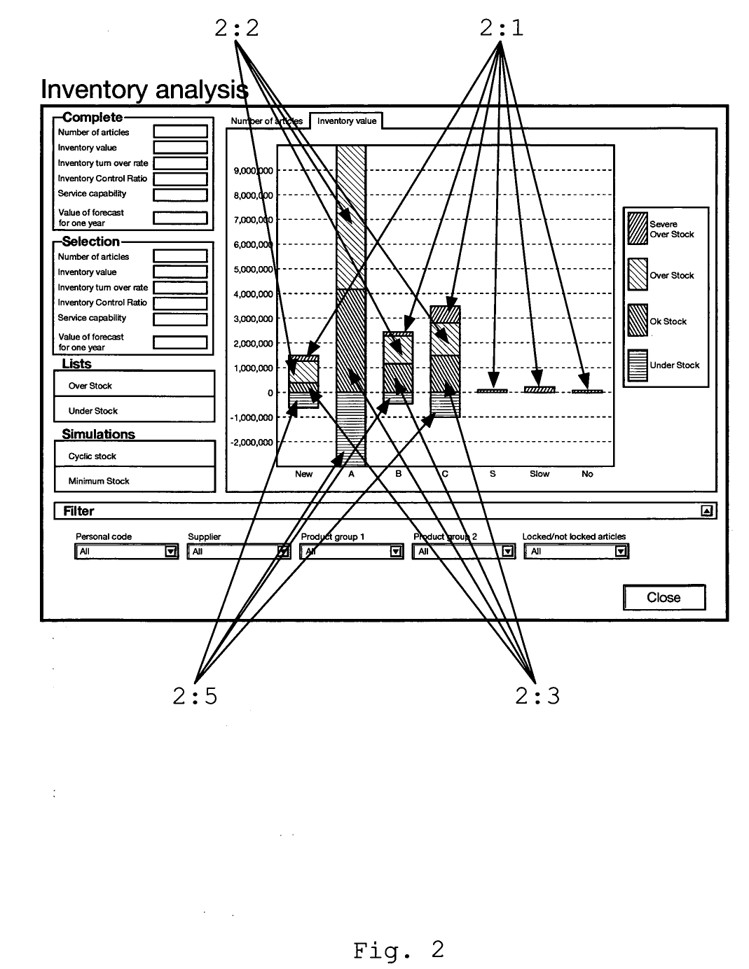

### Relating to FIG. 2

A diagram showing inventory values in the different groups the system is using. The capital invested in inventory can be better used by analysing monetary data such as: inventory values or volumevalues of SKUs.

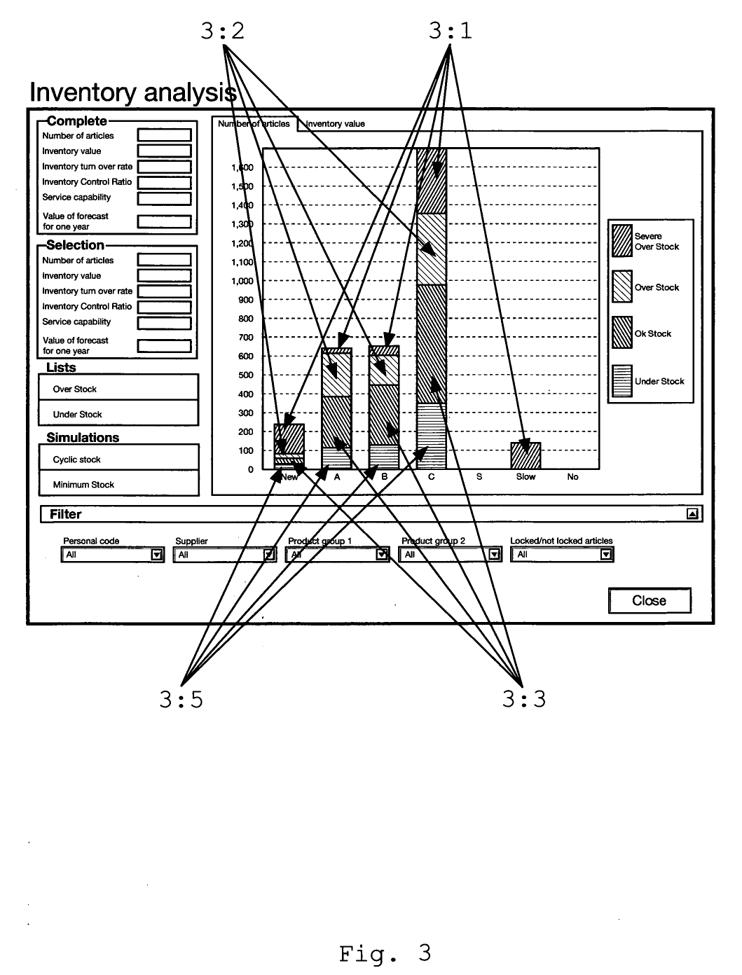

### Relating to FIG. 3

A diagram showing number of articles or SKUs in the different groups the system is using for a filtered group. By filtering using different criteria root causes for Over Stock and under Stock can be identified. The capital invested in inventory can be better used by analysing monetary data such as: inventory values or volumevalues of SKUs.

### Relating to FIG. 4

FIG. 4 shows an example of a filtering menu for the Filtering Function where criteria such as e.g. planner, groups of article numbers, supplier, product groups and demand can be freely combined. Criteria can be set as limits to show SKUs within certain limits regarding for example; Number of orderlines per time unit, number of units sold per time unit, forecasted demand, value per unit, value of deliveries per time unit, value of input delivery quantity, safety stock value per article or SKU, inventory value per article or SKU in average and actual, theoretical inventory value per SKU.

### Relating to FIG. 5

Minimum Stock value have to be increased if inventory availability shall increase. The well-known relationship between Minimum Stock value and inventory availability is combined with an analysis of Actual Inventory to show how the actual Minimum Stock value and the Actual Inventory availability relate to each other. Effects of for instance changes in leadtimes for groups of SKUs can be simulated.

### Relating to FIG. 6

Cyclic stock value increases if the number of input deliveries per time period, e.g. one year, is reduced, that is, if input delivery quantities per article or SKU are increased. The well-known relationship between cyclic stock value and number of input deliveries (the result of the order quantities used) is combined with an analysis of Actual Inventory. The diagram shows how the actual cyclic inventory value and the actual number of input deliveries per time unit relate to each other. Effects in inventory value of for instance changes in order quantities, which directly relates to number of input deliveries, for groups of SKUs can be simulated.

In the method, databases for business systems, inventory control and management systems, for forecasting systems and for supply chain systems, are used to give a precise and flexible presentation of inventory composition quality. The method is a way to very distinctly or precisely express and visualize the composition and actuality of any inventory. The method described herein is also a way to very distinctly or precisely analyse the state or condition of an inventory or a part of an inventory and based on that analysis calculate control orders for the inventory to make the inventory meet set goals. The method described herein also enables the measuring of inventory composition and actuality.

The ICR shows how well or not well the capital invested in inventory is utilised.

To calculate and compare the ICR for different groupings of an inventory's articles or SKUs indicates risks and possibilities for improvement.

The use of diagrams clearly shows the status with a specific marker (1:3, 2:3, 3:3 in FIGS. 1-3) for inventory value where the value is within goals for every item, another marker (1:2, 2:2, 3:2 and 1:4 in FIGS. 1-3) for items where there is a risk that the items have a too high or too low inventory and a yet another marker (1:1, 2:1, 3:1 and 1:5, 2:5, 3:5 in FIGS. 1-3) is indicating a high risk for obsolescence or a high risk for stock-out.

Another feature of the method is a calculation method for inventory capability based on what inventory availability should be reached if exactly the present stock and the present entry of customer order had been present for a longer period of time.

The method also provides an analysis and simulation feature for minimum stocks based on a known relation curve combined with a calculation of the inventory's actual position of minimum stock and service availability. Effects of changed service goals, changed lead times from suppliers and changed forecasting deviations can be simulated, and presented graphically and in table form.

The method also provides an analysis and simulation feature for cyclic stock as a graphical presentation made in a diagram and/or table showing, for a chosen population of articles, the sum value of theoretically calculated cyclic stock as a function of the number of supply orders per year calculated as: (the sum of every article's or SKU's yearly quantity) divided by (the supply order quantity).

The graphical presentation is also showing the effects as a curve if supply order quantities are reduced or increased. The simulated results are presented in the graphical form as well as in figures.

The method described herein may be used as the sole control method of running or managing an inventory, but it may also be used as a part of another, for example on a higher hierarchical level, control method or system, for example a business system, or another system or method for managing an inventory.

### Relating to FIG. 5:

5:1 indicates the relation between inventory availability and Minimum Stock when the Lead time is 100% and the Forecast error is 100%.
5:2a and 5:2b respectively indicate the present setting for Minimum Stock and the corresponding inventory availability.
5:3 indicates/shows the actual/real service capability.
5:4 is a simulation which shows the relation between inventory availability and Minimum Stock when the Lead time and the Forecast error has been changed in comparison to the curve indicated by 5:1, in this simulation, indicated by curve 5:4, the Lead time is 75% and the Forecast error is 80%.

In the simulation/calculation illustrated in FIG. 5 it is possible to see the change in the relation between inventory availability and Minimum Stock when Lead time and/or Forecast error is changed. It can thus be analysed which the effects will be when Lead time and/or Forecast error is changed.

### Terms in the Figures:

Antal artiklar=Number of articles
Lagervärde=Inventory value
Lageroms.=Inventory turn over rate
IMI should read ICR=Inventory Control Ratio
Servicekapabilitet=Service capability
Listor=Lists
Överlager++=Severe Over Stock
Överlager, överlager+=Over Stock
OK lager=Ok Stock
Underlager, underlager−=Under Stock
Underlager−−=Severe Under Stock
Simuleringar=Simulations
Simulering=Simulation
Cykliskt lager=Cyclic stock
Säkerhetslager=Minimum Stock
Filter=Filter
Personkod=Personal code
Leverantör=Supplier
Produktgrupp=Product group
Låsta/ej låsta artiklar=Locked/not locked articles
Värde årsprognos=Value of forecast for one year
Sparat filter=Saved filter
Artikelnummer=Article number
S-artiklar/ej S-artiklar=Special articles/not special articles
Alarm=Alarm
Förbrukning=Consumption
Orderrader=Order lines
Årsförbrukning=Yearly consumption
Årsprognos=Yearly forecast
Ledtid=Lead time
Prognosfel=Forecast error
Min=Minimum value
Max=Maximum value
Pris/st=Price/piece
Volymvärde=Volume value
EOQ=Economical Order Quantity or Input delivery quantity
Säk. Lager=Minimum Stock
Lagervärde (snitt)=Average inventory value
Aktuellt lagervärde=Present inventory value
Teoretiskt lagervärde=Theoretical inventory value
Diagram=Diagram
Lista Plandata=Listing of data for planning
Lista SEK=Listing in monetary units
Säkerhetslagervärde=Value of Minimum Stock
Servicenivå=Service level
Simulera=Simulate
Säkerhetslagervärde vid bibehållen servicenivå=Value of Minimum Stock by preserved service level
Servicenivå vid bibehållet säkerhetslagervärde=Service level by preserved value of Minimum Stock
Täcktid=Coverage time
Täcktid SL=Coverage time for the Minimum Stock
MAD=Mean Absolute Deviation (forecast error)
MAD (%)=Mean Absolute Deviation in percent
Min (kr)=Minimum value in a monetary unit
Max (kr)=Maximum value in a monetary unit
Artikelklass=Article class or article category
Akt. lagervärde=Present inventory value
Teor. lagervärde=Theoretical inventory value
SL/Servicenivå=Minimum Stock/service level
Nuvarande värde=Present value
Kapabilitet=Capability
CL/Inleveranser=Cyclic stock/Number of input deliveries
Antal inleveranser=Number of input deliveries
Cykliskt lagervärde=Value of cyclic stock
Min lagerränta=Minimum inventory holding cost as percentage of value
Max lagerränta=Maximum inventory holding cost as percentage of value
Min ordersärk.=Minimum reordercost
Max ordersärk.=Maximum reordercost
Inleveranser per år=Number of input deliveries per year

1. A method for controlling an inventory, said method comprising the steps of:
a. Selecting at least one article or Stock Keeping Unit according to at least one selection criterion, and
b. Performing at least one analysis on the at least one article or Stock Keeping Unit selected in step a., said analysis enabling the identification of interesting parts of the inventory, these parts being interesting for further investigation, and
c. Performing at least one simulation for the interesting parts of the inventory identified in the at least one analysis performed in step b.,
d. Setting at least one inventory control parameter based on the at least one simulation performed in step c.

2. The method according to claim 1, wherein the at least one selection criterion may be one or more of the following criteria: Stock Keeping Units from a certain source or vendor; Stock Keeping Units within a certain price range; Stock Keeping Units belonging to a certain article group or Stock Keeping Unit group; Stock Keeping Units within a certain range with reference to a characteristic, for example out-delivery frequency; all Stock Keeping Units in the inventory.

3. The method according to claim 1, wherein the at least one analysis in step b. may be one or more of the following: Inventory Control Ratio; Inventory Composition; wherein Inventory Composition may include analysis regarding Ok Stock, Under Stock, Over Stock, Severe Under Stock and/or Severe Over Stock.

4. The method according to claim 1, wherein the at least one simulation in step c. may be one or more of the following: Simulation regarding Minimum Stock; Simulation regarding cyclic stock; Simulation regarding inventory availability; Simulation regarding service capability.

5. The method according to claim 1, wherein the at least one simulation in step c. is performed on a, at least one, part of the inventory which has been selected using a Filtering Function.

6. The method according to claim 5, wherein the Filtering Function is applied on at least one of the interesting parts of the inventory identified in step b. in claim 1.

7. The method according to claim 1, wherein the at least one inventory control parameter is one or more of the following: Input delivery quantity; Input delivery frequency; Reorderpoint; Output delivery quantity; Output delivery frequency.

8. A computer system operating in accordance with the method according to any of the claims 1-7.

9. An inventory operated under the control of the method according to any of the claims 1-7.

10. A method of constructing or building a visual diagram for inventory analysis, comprising:
using a representation that illustrates the Actual Inventory for at least one article, or group of articles, by defining at least one section for the Actual Inventory, preferably at least two sections.

11. The method according to claim 10, wherein the at least one article, or group of articles, have been selected using at least one filtering criterion.

12. The method according to claim 10, wherein the at least one section comprises one or several of the following sections: Ok Stock; Over Stock; Severe Over Stock; Under Stock; Severe Under Stock.
